(19) United States
(12) Patent Application Publication
(10) Pub. No.: US 2018/0319079 A1
(43) Pub. Date: Nov. 8, 2018

(54) NOZZLE FOR THREE-DIMENSIONAL (3D) PRINTING BY A 3D PRINTER

(71) Applicant: Wine Projects Ltd., Isfya (IL)

(72) Inventors: Shay EYAL, Kiryat Bialik (IL); Dima LOKSHIN, Osafia (IL); Michael ROGINSKY, Osafia (IL)

(73) Assignee: Wine Projects Ltd., Isfya (IL)

(21) Appl. No.: 15/970,419

(22) Filed: May 3, 2018

Related U.S. Application Data
(60) Provisional application No. 62/500,549, filed on May 3, 2017.

(51) Int. Cl. B29C 64/209; B29C 64/118; B29C 64/393

(52) U.S. Cl. CPC B29C 64/209; B33Y 10/00; B29C 64/393; B29C 64/118

(57) ABSTRACT

A nozzle for a three-dimensional (3D) printer. The nozzle includes: a first chamber; a second chamber with a spout at a lower end thereof; a shaft disposed within the first chamber with a rod that extends through an aperture at a bottom end of the first chamber to the second chamber; a spring within the first chamber, where the spring biases the shaft toward an upper end of the first chamber; a channel guide configured to receive printing material and connected to the second chamber; an electric coil surrounding the exterior of the first chamber; and a controller communicatively connected to the electric coil and configured to control an electrical current of the electric coil such that a magnetic field is changed to manipulate the position of the shaft and the rod, wherein the rod is extended through the second channel when the shaft is in an extended position.

### CROSS-REFERENCE TO RELATED APPLICATIONS

This application claims the benefit of U.S. Provisional Application No. 62/500,549 filed on May 3, 2017, the contents of which are hereby incorporated by reference.

### TECHNICAL FIELD

The present disclosure relates generally to systems and methods of three-dimensional (3D) printing, and, more specifically, to a nozzle configured to ensure the accurate printing of material being extruded from a 3D printer.

### BACKGROUND

Three-dimensional (3D) printers are manufacturing units designed to create a three-dimensional object by injecting material through an extruder layer by layer under computer control to create a desired object. 3D printers allow for the creation of a variety of products, parts, and the like, that can be used for producing, for example, toys for children, parts for cars, components for the high-tech industry, weapons, and more.

The technology currently used by most 3D printers is called fused deposition modeling (FDM), which creates objects using an “additive” principle by laying down material in multiple layers. A plastic filament or metal wire is unwound from a coil and supplies material to produce a 3D object. The 3D object is produced by extruding small flattened strings of molten material to form layers, where the material hardens immediately after extrusion from a nozzle of the 3D printer.

One significant disadvantage of existing 3D printers is the limited accuracy of the final product. Reasons for such limits may include inconsistency of a material's viscosity, changes in the material's and printer's temperatures during the 3D printing process, and variables relating to the pressure applied to a tank containing the material to be extruded, where the pressure controls at least part of the extrusion process.

Another disadvantage of existing 3D printers is that the nozzles often clog up during printing, which can negatively affect the final printed object, as well as the 3D printer itself. Currently, in order to prevent the nozzle from clogging, a user is often required to perform various maintenance procedures, such as cleaning the nozzles manually using different cleaning liquids and tools, increasing the temperature of the nozzles for a period of time to enable the material to melt and flow more easily, and similar actions, which are often inefficient, time consuming, and costly.

It would therefore be advantageous to provide a solution that would overcome the disadvantage noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a nozzle for a three-dimensional (3D) printer, the nozzle including: a first chamber having a first interior volume; a second chamber having a second interior volume, with a spout at a lower end of the second chamber; a shaft disposed within the first interior volume with a rod extending from the first chamber through an aperture at a bottom end of the first chamber to the second chamber; a spring disposed within the interior volume of the first chamber, where the spring biases the shaft toward an upper end of the first chamber; a channel guide with a first end configured to receive printing material and a second end connected to the second chamber, the channel guide configured such that printing material flows from the first end to the second end; an electric coil surrounding the exterior of the first chamber; and a controller communicatively connected to the electric coil and configured to control an electrical current of the electric coil such that a magnetic field is changed to manipulate the position of the shaft and the rod, wherein the rod is extended through the second channel when the shaft is in an extended position.

Certain embodiments disclosed herein also include a method for controlling a nozzle of a 3D printer, the method including: determining a current position of printing material within a nozzle of a 3D printer; determining a current temperature of the printing material; and adjusting the position of a rod within the nozzle to extrude the printing material at a desired rate.

Certain embodiments disclosed herein also include a non-transitory computer readable medium having stored thereon instructions for causing a processing circuitry to perform a process for method for a nozzle of a 3D printer, the process including: determining a current position of printing material within a nozzle of a 3D printer; determining a current temperature of the printing material; and adjusting the position of a rod within the nozzle to extrude the printing material at a desired rate.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a sectional view of a nozzle for a 3D printer according to an embodiment.

FIG. 2 is a schematic block diagram of a controller adapted to control the nozzle of the 3D printer according to an embodiment.

FIG. 3 is a flowchart of a method of accurate 3D printing according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Some example embodiments include a nozzle for a 3D printer that includes a first chamber and a second chamber. The first chamber includes a shaft with a rod attached thereto, where the rod extends toward the bottom of the first chamber and into an adjacent second chamber. A spring surrounds the rod and bias the shaft toward the top of the first chamber. The nozzle further includes a channel guide that extends into the second chamber at an angle and is configured to receive material to be extruded through the nozzle from a spout at the bottom end of the second chamber, where the material is driven by the rod. An electric coil is placed externally around the first chamber. A controller is connected to the electric coil and configured to adjust the electrical current running therethrough, which causes the shaft to compress the spring and extend the rod into the second chamber such that it is pushed against the material, forcing it to extrude out of the spout.

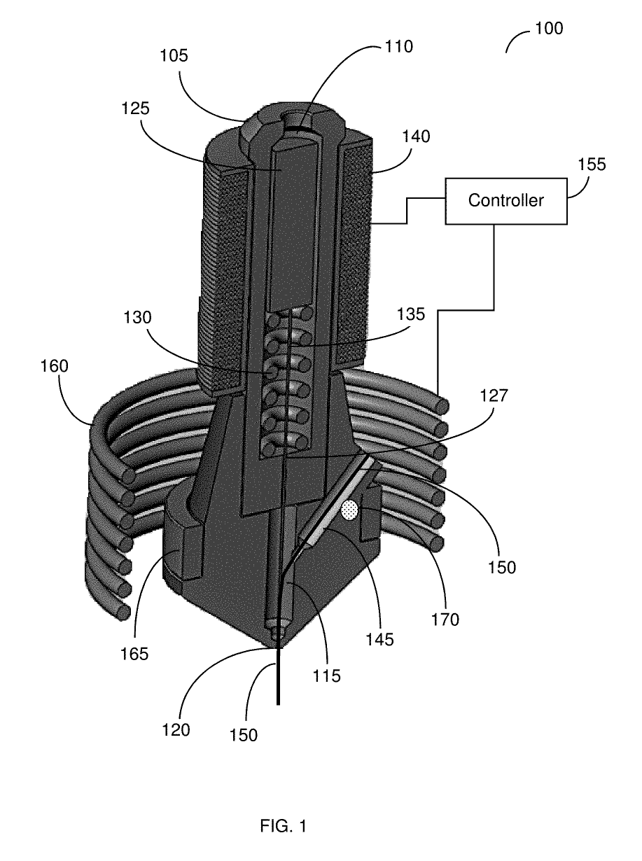

FIG. 1 is a sectional view of a nozzle 100 for a 3D printer according to an embodiment. The nozzle 100 includes a nozzle body 105 having a first chamber 110 and a second chamber 115. The first chamber 110 has a first interior volume with first diameter and a first length, and the second chamber 115 has a second interior volume with a second diameter and second length. In an embodiment, the second diameter is smaller than the first diameter. The second chamber 115 is adjacent to the first chamber 110 and further includes a spout 120 at a bottom end of the second chamber 115. Material 150 is extruded through the nozzle 100 and discharged by the spout 120. Depending on the type or configuration of the 3D printer, various types of materials 150 may be used, including plastic, metal, ceramic, food substances, and the like.

The nozzle 100 further includes a shaft 125 placed within the first interior volume of the first chamber 110. The shaft 125 may be made of at least one substance that is affected by a magnetic field, such as a ferromagnetic material. The shaft 125 has a shaft length that is shorter than the first length of the first chamber 110, allowing the shaft 125 to move lengthwise within the first chamber 110. The nozzle 100 further includes a spring 130 placed within the first chamber 110. The spring 130 is designed to bias the shaft 125 toward a top end of the first chamber 110 when the spring 130 is an extended position, where one end of the spring 130 is in contact with the shaft 125 and the other end of the spring 130 is in contact with a bottom of the first chamber 110.

The nozzle 100 further includes at least one rod 135 attached to the shaft 125 which extends toward the bottom of the first chamber 110 and further extends through an outlet 127 connected to the second chamber 115. The rod 135 may be configured to push any material 150 present in the second chamber 115 toward the spout 120 as further described herein below. An electric coil 140 is placed externally around the nozzle 100 where the first chamber 110 is located. The electric coil 140 is configured to change a magnetic field based on a received electrical current, which causes a shift in the position of the shaft 125 and the position of the rod 135 as further described herein below. The magnetic field that is introduced by the electric coil 140 manipulates the shaft 135 to either move downwards toward the end of the first chamber 110 or upwards toward the top of the first chamber 110, based on the amount of electrical current provided to the electric coil 140.

The nozzle 100 further includes a channel guide 145 configured to receive material 150 therein. The channel guide 145 extends into the second chamber 115 at an angle, where a lower end of the channel guide 145 is directed toward the spout 120. The channel guide 145 is configured to position the material 150 to be extruded through the spout 120 by the rod 135.

According to an embodiment, a controller 155 is communicatively connected to the electric coil 140 and adapted to control an electrical current running therethrough for controlling and manipulating a magnetic field, based on received instructions, to cause the shaft 125 to travel toward the second chamber 115, compressing the spring 130 and causing the rod 135 to extend such that it pushes against the material 150 received from the channel guide 145 toward the spout 120. The controller 155 is further configured, based on received instructions, to reduce or stop the electrical current that flows through the electric coil 140, thus removing or reducing the electromagnetic force on the shaft 125, such that the force of the spring 130 extends and biases the shaft 125 toward the top of the first chamber 110. As the electrical current can be controlled precisely, extruding the material 150 through the nozzle 100 using the technique described herein allows the nozzle 100 to extrude the material 150 with accurate and precise results.

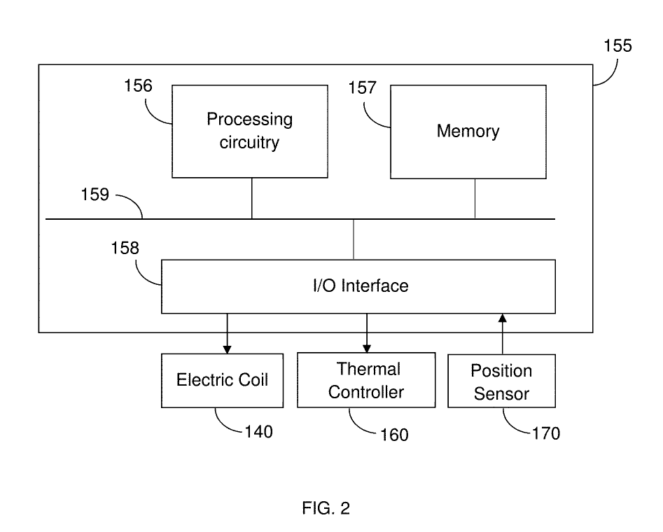

In an example embodiment, the controller 155 includes a processing circuitry and memory (not shown in FIG. 1), as further described in FIG. 2 below, and may be configured to receive instructions corresponding to a specific 3D printing plan for a 3D object. The controller 155 may generate a printing plan based on the received instructions, where the plan includes the specific amounts and sequence of electrical currents required for operating the electric coil 140 at each step of the 3D printing process to complete the printing plan.

The components of the nozzle 100 that have been described herein above, specifically the extending rod 135, enables the nozzle 100 to prevent the material 150 extruded through the nozzle 100 from clogging the spout 120. Thus, by using the rod 135 to extend through the second chamber 115 and push the material 150 through the spout 120, the spout 120 is kept free of any undesired blockage caused by dried or hardened material 150.

According to an embodiment, the nozzle 100 further includes a thermal controller 160 that is connected to the controller 155. The thermal controller 160 consists of an electric coil. The thermal controller 160 is placed around a ferromagnetic module 165. Such an arrangement enables an electric coil of the thermal controller 160 to create a magnetic field between the thermal controller 160 and the ferromagnetic module 165. The magnetic field causes the ferromagnetic module 165 to change its temperature and thus, to adjust the temperature of the material 150 extruded through the nozzle 100, the temperature of the nozzle 100 itself, or both. In an embodiment, the ferromagnetic module 165 is attached to the exterior of the second chamber 115.

According to one embodiment, at least one sensor 170 may be placed within or attached to the nozzle 100. The sensor 170 may be connected to and controlled by the controller 155. The sensor 170 enables the detection of data corresponding to various parameters, such as, e.g., the position of the material 150 within one or more parts of the nozzle 100, the flow of the material 150, the temperature of the material 150 at different portions of the nozzle 100, the electrical current in the electric coil 140, and the like. For example, the sensor 170 may include a position sensor adapted to sense the position of the material 150 within the channel guide 145 or the second chamber 115. According to a further embodiment, the electrical current may flow constantly through the electric coil 140, causing the shaft to remain in the position of the depressed spring 130 and blocking any future material 150 flowing in to prevent the formation of any undesirable blockage.

A 3D printer may be configured to be used with a plurality of nozzles 100. The plurality of nozzles 100 may be controlled by, for example, a single controller 155. Thus, each nozzle 100 may be configured to execute at least a portion of a received 3D printing plan. In an embodiment, the plurality of nozzles 100 may operate simultaneously, allowing for an increased speed of the printing process.

FIG. 2 is a schematic block diagram of a controller 155 adapted to control the nozzle 100 of the 3D printer according to an embodiment. The controller 155 includes a processing circuitry 156, a memory 157 and an input/output (I/O) interface 158.

The processing circuitry 156 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

In another embodiment, the memory 157 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions cause the processing circuitry 156 to perform the various processes described herein. Specifically, the instructions, when executed, cause the processing circuitry 156 to control the nozzle 100, and various components thereof, as discussed herein.

The processing circuitry 156 is configured to receive data corresponding to processes associated with the nozzle's 100 operation, such as a 3D printing plan, analysis and calculation of data, and determination of appropriate commands to be executed by the nozzle 100 based on the analysis of the data. According to one embodiment, the controller 155 is configured to time the operation of the shaft 125, and therefore the position of the rod 135, by controlling the electrical current in the electric coil 140 that pushes the shaft 125 upwards and downwards within the first chamber 110 of the nozzle 100.

The input/output (I/O) interface 158 is configured to send or receive operational commands to and from an electric coil 140 and a thermal controller 160 in order to perform the various tasks determined by the processing circuitry 156. The various tasks may include increasing or decreasing the electrical current flowing through the electric coil 140, changing the nozzle 100 or material 150 temperature via the thermal controller 160, and the like. According to another embodiment, the I/O interface 158 is configured to collect data from at least one sensor 170, such as a position sensor. The components of the controller 155 may be communicatively connected via a bus 159. According to an embodiment, the I/O interface 158 may be further configured to receive instructions from an external source, e.g., a computer or server (not shown), over a wired or wireless connection, such as a Bluetooth connection or Wi-Fi network.

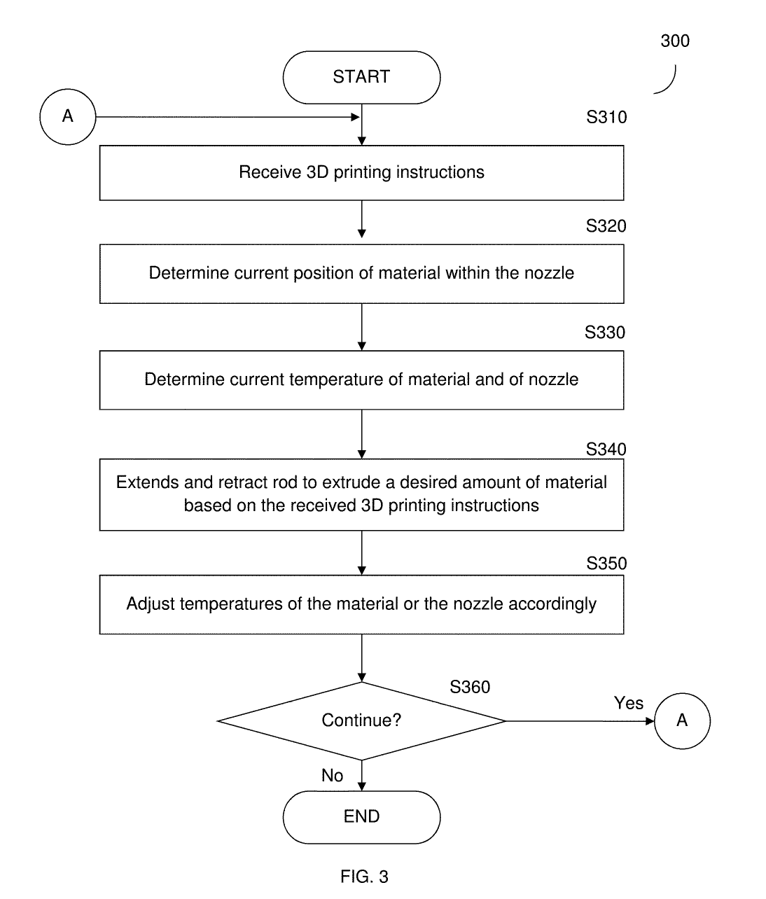

FIG. 3 is an example flowchart of a method 300 of accurate 3D printing according to an embodiment. At S310, 3D printing instructions are received. 3D printing instructions include a set of steps designed to create a specific 3D object using a 3D printer. The 3D printing instructions may be received from a computer or server, e.g., over a network, and may include a file containing instructions regarding the movements and operation of a 3D printer and a 3D printer nozzle or nozzles, including how a material, e.g., a printing material, is to be manipulated and moved through the nozzle.

At S320, the current position of the material within the nozzle of the 3D printer is determined. The position of the material includes where an end of the material is located within the nozzle, how much material is within a channel guide, whether the material has reached a predetermined position within the nozzle, and the like. The predetermined position may be for example, 5 millimeters before the end of the channel guide. The determination may be achieved by collecting data corresponding to the position of the material from at least one sensor, such as from a position sensor disposed within the nozzle.

At S330, the current temperatures of the material and of the nozzle are determined. In an embodiment, the temperatures are determined based on one or more temperature sensors, such as a thermostat, a thermistor, a thermocouple, and the like.

At S340, a rod within the nozzle of the 3D printer is extended or retracted to cause a desired amount of material to be extruded from the nozzle at a desired rate based on the received 3D instructions, the determined material position, and the determined temperatures of the material and the nozzle.

In an embodiment, as discussed above, the rod is controlled via a controller that adjusts an electrical current that flows through an electric coil attached to the nozzle. The electrical current manipulates a magnetic field that causes a shaft to compress a spring within the nozzle and extend the rod such that the material is pushed toward a spout of the nozzle.

In an embodiment, the operation begins when the rod is held in an upper position by a spring. The material enters the nozzle through a channel guide at an angle directed toward the nozzle's spout. The material is extruded by increasing the magnetic field around the electric coil to cause the shaft to extend the rod to push out the material at an optimal rate. When the rod reaches the end of its movement range, the electrical current that flows through the electric coil is reduced, the magnetic field subsides, and the rod retracts. According to another embodiment, the rod may be pushed against the material while using only a fraction of its full range of motion. For example, the received 3D printing plan may only requires the rod to extend 60% of its possible range of motion, while still pushing the material through the spout.

At optional S350, based on the sensor readings and the received instructions, the temperatures of the material, of the nozzle, or both are adjusted to ensure that the desired 3D object is printed as accurately as possible. For example, if it is determined that the material currently has low viscosity and is flowing too slowly to produce the desired result, the temperature of the nozzle or the material may be adjusted, e.g., via a thermal controller. Both the viscosity and the speed of the extrusion may be monitored to ensure optimal material flow. In an embodiment, the optimal material flow is based on the received 3D printing instructions.

At S360, it checked whether to continue the operation and if so, execution continues with S310; otherwise, execution terminates.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A nozzle for a three-dimensional (3D) printer, comprising:
a first chamber having a first interior volume;
a second chamber having a second interior volume, with a spout at a lower end of the second chamber;
a shaft disposed within the first interior volume with a rod extending from the first chamber through an aperture at a bottom end of the first chamber to the second chamber;
a spring disposed within the interior volume of the first chamber, where the spring biases the shaft toward an upper end of the first chamber;
a channel guide with a first end configured to receive printing material and a second end connected to the second chamber, the channel guide configured such that printing material flows from the first end to the second end;
an electric coil surrounding the exterior of the first chamber; and
a controller communicatively connected to the electric coil and configured to control an electrical current of the electric coil such that a magnetic field is changed to manipulate the position of the shaft and the rod, wherein the rod is extended through the second channel when the shaft is in an extended position.

2. The nozzle of claim 1, further comprising:
a thermal controller configured to adjust the temperature of the nozzle.

3. The nozzle of claim 1, further comprising:
a ferromagnetic module, wherein the thermal controller comprises an electric coil and controls the ferromagnetic module by generating a magnetic field between the coil and the ferromagnetic module to cause a change in temperature of the material or the nozzle.

4. The nozzle of claim 1, further comprising
a sensor configured to determine the position of printing material within the nozzle.

5. The nozzle of claim 4, wherein the sensor is a position sensor configured to determine the position of the material within the channel guide.

6. The nozzle of claim 5, wherein the controller is further configured to control the electrical current of the electric based on the determined position of the printing material within the nozzle.

7. The nozzle of claim 1, wherein the controller is further configured to adjust the electrical current of the electric coil to manipulate the position of the shaft within the first chamber.

8. The nozzle of claim 7, further comprising:
an input/output (I/O) interface, wherein I/O interface is configured to receive 3D printing instructions over a network connection.

9. A method for controlling a nozzle of a 3D printer, comprising:
determining a current position of printing material within a nozzle of a 3D printer;
determining a current temperature of the printing material; and
adjusting the position of a rod within the nozzle to extrude the printing material at a desired rate.

10. The method of claim 9, wherein the desired rate is determined based on received instructions.

11. The method of claim 10, wherein the desired rate is further based on at least one of: the determined current position of the printing material, and the determined current temperature of the printing material.

12. The method of claim 9, further comprising:
adjusting the temperature of the printing material to adjust its viscosity to ensure optimal flow, where the optimal flow is based on received 3D printing instructions.

13. A non-transitory computer readable medium having stored thereon instructions for causing a processing circuitry to perform a process for method for a nozzle of a 3D printer, the process comprising:
determining a current position of printing material within a nozzle of a 3D printer;
determining a current temperature of the printing material; and
adjusting the position of a rod within the nozzle to extrude the printing material at a desired rate.
